(19) United States
(12) Patent Application Publication
(10) Pub. No.: US 2010/0326295 A1
(43) Pub. Date: Dec. 30, 2010

(54) Imparting Pattern into Material Using Embossing Roller

(76) Inventor: David A. Champion, Lebanon, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/865,247

(22) PCT Filed: Mar. 1, 2008
(86) PCT No.: PCT/US08/55578

§ 371 Date: Jul. 29, 2010

(51) Int. Cl. B31F 1/07

(52) U.S. Cl. 101/23; 101/32

(57) ABSTRACT

An embossing roller and a backing roller are positionally maintained so that the embossing roller and the backing roller define a gap therebetween. The temperature of the backing roller is maintained below a reference temperature. Material is fed between the embossing roller and the backing roll, where the material has been heated to a temperature greater than the reference temperature. As the material passes between and makes contact with the embossing roller and the backing roll, the embossing roller imparts a predefined pattern into the material. As the temperature of the embossing roller increases due to contact with the material, the temperature of the embossing roller is reduced so that it remains below the temperature of the material but above the reference temperature.

### BACKGROUND

Embossing is the process of imparting a three-dimensional pattern into a material. For example, an embossing roller may have the three-dimensional pattern defined on its surface. The material is passed between the embossing roller and a backing roller, such that the embossing roller imparts the pattern into the material. So that the pattern is properly imparted into the material, the material is typically heated before passing between the embossing roller and the backing roller, and the embossing roller and the backing roller are conversely cooled.

However, this configuration can lead to problems during the embossing process. Water can condense on the embossing roller and remaining within deeper portions of the pattern, such that these aspects of the pattern are not properly embossed into the material due to the water remaining between the embossing roller and the material. Furthermore, water can condense on the backing roller and be transferred to the embossing roller when the embossing roller and the backing roller come into contact with one another prior to the material passing between the embossing roller and the backing roller.

### BRIEF DESCRIPTION OF THE DRAWINGS

FIG. 1 is a diagram illustratively depicting an embossing process, in relation to which embodiments of the present disclosure may be practiced.

FIG. 2 is a flowchart of a method for embossing a pattern into a material, according to an embodiment of the present disclosure.

FIGS. 3A and 3B are diagrams illustratively depicting aspects of the method of FIG. 2, according to an embodiment of the present disclosure.

FIG. 4 is a diagram of a rudimentary embossing system, according to an embodiment of the present disclosure.

### DETAILED DESCRIPTION OF THE DRAWINGS

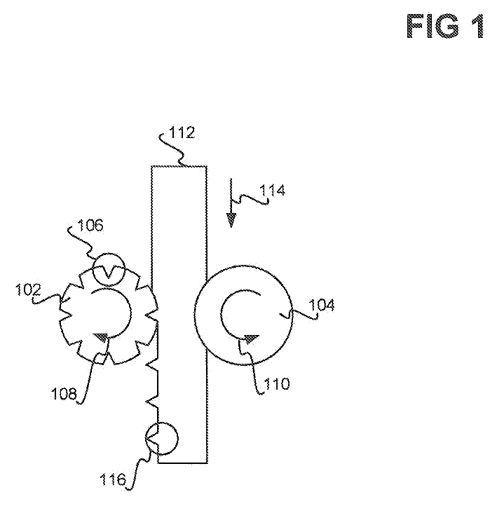

FIG. 1 illustratively depicts an embossing process, in relation to which embodiments of the present disclosure may be practiced. An embossing roller 102 has a three-dimensional pattern defined on its surface. In the example of FIG. 1, this pattern is exemplified as a number of saw teeth, such as the saw tooth 106. The embossing roller 102 is typically fabricated from a hard material, such as metal. Oppositely positioned to the embossing roller 102 is a backing roller 104. The backing roller 104 is typically fabricated from a relatively flexible material, such as rubber.

A material 112, such as a sheet of vinyl, is passed between the embossing roller 102 and the backing roller 104. The embossing roller 102 rotates clockwise, as indicated by the arrow 108, while the backing roller rotates counter-clockwise, as indicated by the arrow 110. The material 112 is fed between the embossing roller 102 and the backing roller 104 as the rollers 102 and 104 rotate in their respective directions, as indicated by the arrow 114.

The three-dimensional pattern defined by the embossing roller 102 is imparted into the material 112. Thus, the saw teeth of the embossing roller 102 cause corresponding saw tooth impressions within the material 112, such as the saw tooth 116. It is therefore said that the embossing roller 102 has imparted its three-dimensional pattern into the material 112. It is noted that the pattern on the surface of the embossing roller 102 is the mirror opposite in the radial direction of the roller 102 to the pattern that is ultimately imparted into the material 112: For example, in FIG. 1, the saw teeth depress into the embossing roller 102, while the saw teeth protrude from the material 112.

In relation to embodiments of the present disclosure, the pattern of the embossing roller may have features (e.g., the saw teeth in FIG. 1) that are measurable down to microns along the x, y, and z directions. As such, should any liquid condense on the embossing roller 102 due to the embossing roller 102 being cooled, the liquid can greatly deleteriously affect embossing of the pattern into the material 112 due to the liquid becoming trapped between the roller 102 and the material 112. Likewise, any liquid that condenses on the backing roller 104 can be transferred if the embossing roller 102 is in contact with the backing roller 104 prior to the material 112 being fed between the rollers 102 and 104, which also can deleteriously affect embossing of the pattern into the material 112.

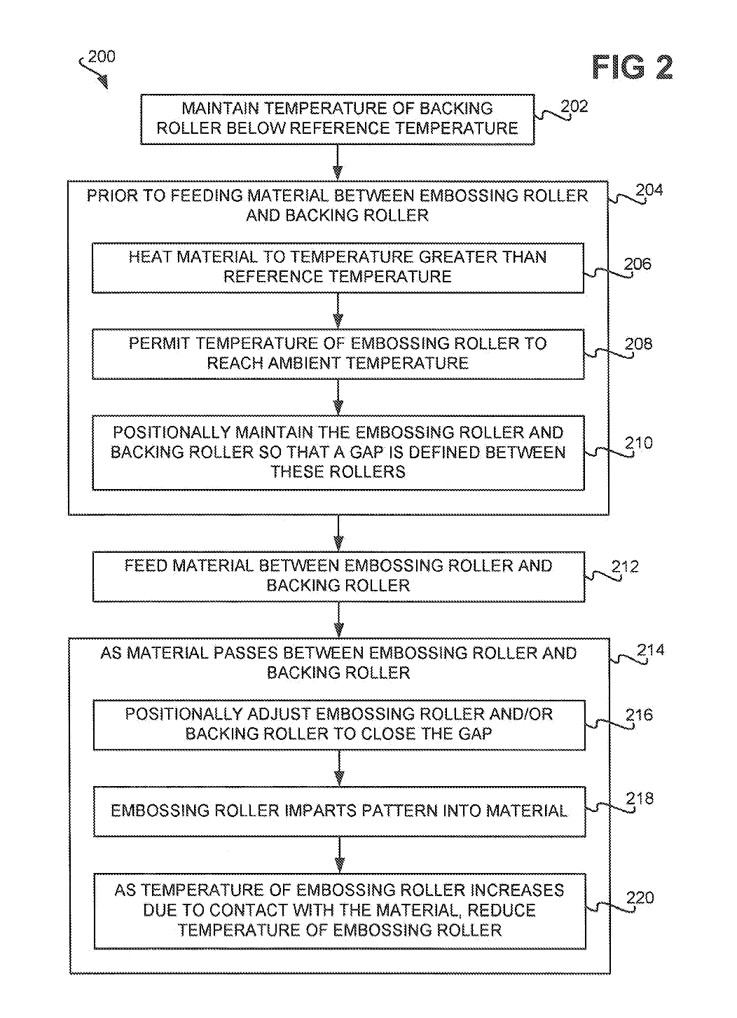

FIG. 2 shows a method 200, according to an embodiment of the present disclosure. The method 200 can be at least substantially implemented as one or more computer programs stored on a computer-readable medium. The method 200 provides for the embossing of the material 112 via the embossing roller 102 while at least substantially reducing the disadvantages described in the background section. In particular, first, the method 200 ensures that any liquid condensing on the backing roller 104 is not transferred to the embossing roller 102. Second, the method 200 ensures that liquid does not condense on the embossing roller 102. In this way, the method 200 ensures that the three-dimensional pattern of the embossing roller 102 is properly imparted into the material 112.

The temperature of the backing roller 104 is maintained below a reference temperature during performance of the remainder of the method 200 (202). The reference temperature in one embodiment may be the ambient temperature of the room in which the embossing roller 102, the backing roller 104, and the material 112 are located. For instance, in one embodiment, the temperature of the backing roller 104 may be maintained so that it is substantially twenty degrees Fahrenheit below the reference temperature. The backing roller 104 may be maintained at a temperature below the reference temperature by passing coolant, such as water, through the backing roller 104, as can be appreciated by those of ordinary skill within the art.

Prior to feeding the material 112 between the embossing roller 102 and the backing roller 104, the following is performed (204). The material 112 is heated to a temperature greater than the reference temperature (206). The reference temperature again may in one embodiment be the ambient temperature of the room in which the embossing roller 102, the backing roller 104, and the material 112 are located. For instance, in one embodiment, the material 112 may be heated to a temperature that is substantially 340 degrees Fahrenheit above the reference temperature. The material 112 may be heated by passing the material 112 adjacent to a heating element, as can be appreciated by those of ordinary skill within the art.

By comparison, the temperature of the embossing roller 102 is permitted to reach the ambient temperature (208). For instance, in one embodiment, the embossing roller 102 is neither heated nor cooled in part 208, such that it naturally reaches an equilibrium temperature equal to the ambient temperature. In this way, it may be said that the embossing roller 102 is maintained at substantially at the ambient temperature. In another embodiment, the embossing roller 102 may be heated and/or cooled in part 208 so that it reaches the ambient temperature, if conditions dictate.

Heating the material 112 and cooling the backing roller 104, while permitting the embossing roller 102 to stay at the ambient temperature, has been found to be sufficient to properly impart a three-dimensional pattern of the roller 102 into the material 112 during embossing. That is, within the prior art, typically the embossing roller 102 is cooled below the reference temperature along with the backing roller 104 while the material 112 is heated to properly impart a three-dimensional pattern of the roller 102 into the material 112 during embossing. However, it is has been found that sufficient imparting of the pattern into the material 112 can nevertheless occur where the embossing roller 102 is not cooled below the reference temperature.

Furthermore, the embossing roller 102 and the backing roller 104 are positionally maintained in relation to one another so that a gap is defined between the rollers 102 and 104 before the material 112 is fed between the rollers 102 and 104 (210). This is in contradistinction to the prior art, in which the embossing roller 102 and the backing roller 104 are in contact with one another before the material 112 is fed between them and pushes the rollers 102 and 104 apart. The gap between the rollers 102 and 104 is maintained in part 210 so that any liquid, such as water, that condenses on the backing roller 104 due to the backing roller 104 being cooled below the reference temperature is not transferred to the embossing roller 102.

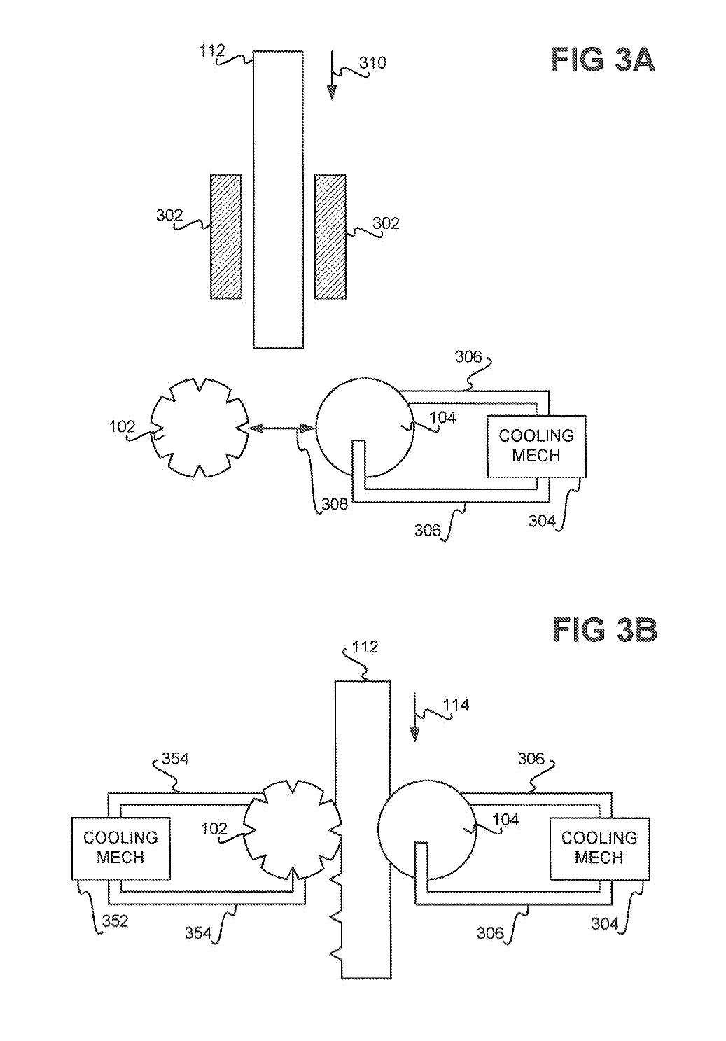

FIG. 3A illustratively depicts performance of parts 202 and 204 of the method 200, according to an embodiment of the present disclosure. The embossing roller 102 is neither heated nor cooled, and thus stays at the ambient temperature of the room in which the embossing roller 102 and the backing roller 104 are located. By comparison, a cooling mechanism 304, which may be or include a pump and/or a compressor, circulates coolant, such as water, through the backing roller 104 via tubing 306. The cooling mechanism 304 cools the temperature of the backing roller 104 to be below the reference temperature, such as the ambient temperature.

Furthermore, the material 112 is moved through or adjacent to a heating mechanism 302, as indicated by the arrow 310. The heating mechanism 302 may be in the form of heating plates as depicted in FIG. 3A, or may be another type of heating mechanism. The embossing roller 102 and the backing roller 104 are positionally maintained or adjusted so that there purposefully is a gap 308 between them, even before the material 112 passes through the rollers 102 and 104. As such, any liquid that condenses on the backing roller 104 is not transferred to the embossing roller 102.

Referring back to FIG. 2, the material 112 is fed between the embossing roller 102 and the backing roller 104 (212). As the material 112 passes between the embossing roller 102 and the backing roller 104, the following is performed (214). First, the embossing roller 102 and/or the backing roller 104 are positionally adjusted in relation to one another so that the gap 308 between them is closed (216). But for the material 112 passing between the embossing roller 102 and the backing roller 104, the rollers 102 and 104 would touch (i.e., come into contact with one another) at this time. However, the material 112 passing through the embossing roller 102 and the backing roller 104 prevents the rollers 102 and 104 from touching at this time.

The embossing roller 102 imparts its three-dimensional pattern into the material 112 (218), as has been described in relation to FIG. 1. This contact of the embossing roller 102 with the material 112 causes the embossing roller 102 to rise in temperature. As the temperature of the embossing roller 102 increases due to this contact with the material 112, however, the temperature of the embossing roller 102 is reduced (220). In particular, the temperature of the embossing roller 102 is reduced so that it is below the temperature of the material 112, but still greater than the reference temperature by a given range. This range in one embodiment may be five to twenty degrees Fahrenheit above the reference temperature, which may be the ambient temperature of the room in which the embossing roller 102, the backing roller 104, and the material 112 are located.

The embossing roller 102 may be reduced in temperature by passing coolant, such as water, through the embossing roller 102, as can be appreciated by those of ordinary skill within the art. Cooling the embossing roller 102 so that its temperature is less than the temperature of the material 112 is achieved so that the embossing roller 102 properly imparts its three-dimensional pattern into the material 112. However, cooling the embossing roller 102 so that its temperature nevertheless remains above the reference temperature prevents liquid, such as water, from condensing on the embossing roller 102. Thus, embossing properly occurs without the deleterious effects that can result from liquid condensing on the embossing roller 102.

FIG. 3B illustratively depicts performance of parts 212 and 214 of the method 200, according to an embodiment of the present disclosure. The backing roller 104 is still maintained at a temperature below the reference temperature due to the cooling mechanism 304 passing coolant, such as water, through the roller 104 via the tubing 306. The gap 308 of FIG. 3A has been closed in FIG. 3B, such that the embossing roller 102 and the backing roller 104 would come into contact with one another but for the material 112 passing between the rollers 102 and 104. The embossing roller 102 and the backing roller 104 may be positionally adjusted from FIG. 3A to FIG. 3B to close the gap 308 via a positional mechanism that is able to move the roller 102 and/or the roller 104, such as by one or more motors, and so on, as can be appreciated by those of ordinary skill within the art.

The material 112, which remains heated due to its passing adjacent to or through the heating mechanism 302 in FIG. 3A, is fed and passes between the embossing roller 102 and the backing roller 104, as indicated by the arrow 114. As has been described in relation to FIG. 1, the embossing roller 102 imparts its three-dimensional pattern into the material 112. In so doing, the embossing roller 102 comes into contact with the material 112, which causes the embossing roller 102 to undesirably increase in temperature, since for optimal embossing to occur, the roller 102 is desirably at a temperature that is less than the material 112.

Therefore, a cooling mechanism 304 passes coolant, such as water, through the embossing roller 102 via tubing 354. The cooling mechanism 304 ensures that the temperature of the embossing roller 102 is less than the temperature of the material 112. However, at the same time, the cooling mechanism 304 does not decrease the temperature of the embossing roller 102 below the reference temperature, such as the ambient temperature. Rather, the cooling mechanism 304 ensures that the temperature of the embossing roller 102 maintains above the ambient temperature. Because the temperature of the embossing roller 102 is greater than the ambient temperature, liquid, such as water, does not condense on the embossing roller 102.

The method 200 thus prevents liquid from being deposited on the embossing roller 102, such that the deleterious effects of such liquid on the embossing roller 102 as to the embossing process are at least substantially reduced or prevented. First, any liquid that condenses on the backing roller 104 is not transferred to the embossing roller 102, due to the maintenance of the gap 308 prior to the material 112 passing between the rollers 102 and 104. Second, liquid is at least substantially prevented from condensing on the embossing roller 102, due to the embossing roller 102 being maintained at a temperature greater than the ambient temperature.

It is noted that preventing liquid from being deposited on the embossing roller 102 is achieved in the method 200 without having to add any expensive environmental controls. For instance, the humidity of the room in which the embossing roller 102, the backing roller 104, and the material 112 are located does not have to be controlled to a low level via installation of dehumidifiers. Such dehumidification would prevent liquid from condensing on either the backing roller 104 or the embossing roller 102, but at expensive installational and/or operational cost. By comparison, the method 200 ensures that any liquid that does condense on the backing roller 104 is simply not transferred onto the embossing roller 102, and that no liquid condenses on the embossing roller 102.

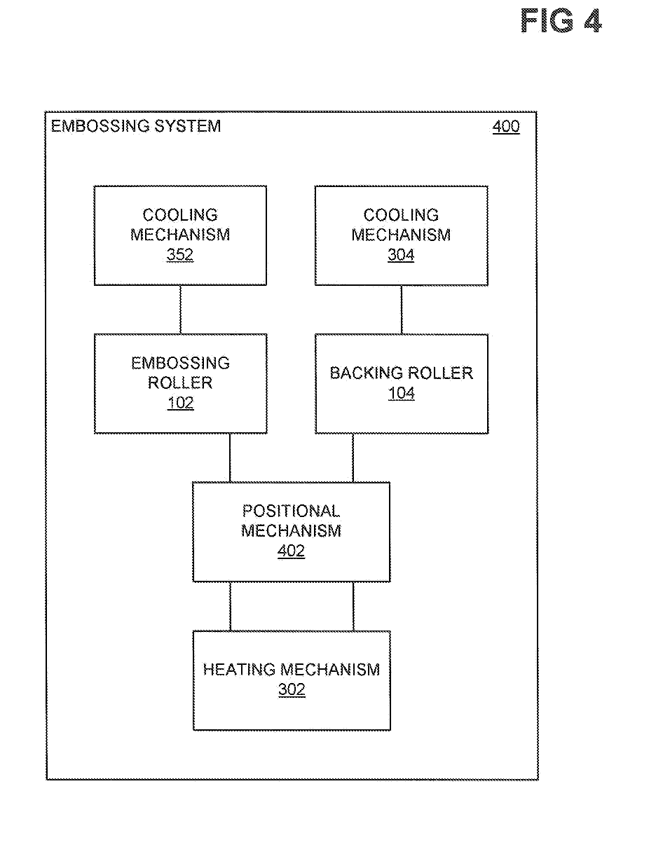

In conclusion, FIG. 4 shows a rudimentary system 400, according to an embodiment of the present disclosure. The system 400 includes the embossing roller 102, the backing roller 104, the heating mechanism 302, and the cooling mechanisms 304 and 352 that have been described, as well as a positional mechanism 402. The system 400 can include other components and/or mechanisms, in addition to and/or in lieu of those depicted in FIG. 4, as can be appreciated by those of ordinary skill within the art.

The embossing roller 102 is a hard roller having a three-dimensional pattern on its surface. By comparison, the backing roller 104 is a flexible roller. The material 112 passes between the rollers 102 and 104, such that the embossing roller 102 imprints or imparts its pattern into the material 112, where the backing roller 104 serves as a backing during this embossing process. The heating mechanism 302 heats the material 112 prior to the material 112 passing between the embossing roller 102 and the backing roller 104. As has been noted, the heating mechanism 302 may be in the form of heating plates, or another type of heating mechanism.

The cooling mechanisms 304 and 352 cool the backing roller 104 and the embossing roller 102, respectively. As has been noted, the cooling mechanisms 304 and 352 may pass coolant, such as water or another type of coolant, through the rollers 104 and 102 to decrease their temperatures as desired. The positional mechanism 402 maintains the gap 308 between the embossing roller 102 and the backing roller 104 prior to the material 112 passing between the rollers 102 and 104. Thereafter, the positional mechanism 402 closes the gap 308 as the material 112 is fed between the rollers 102 and 104. The position mechanism 402 can include motors, and so on, in this respect, as can be appreciated by those of ordinary skill within the art.

We claim:

1. A method comprising:
positionally maintaining an embossing roller and a backing roller so that the embossing roller and the backing roller define a gap therebetween;
maintaining a temperature of the backing roller below a reference temperature;
feeding material between the embossing roller and the backing roll, the material having been heated to a temperature greater than the reference temperature;
as the material passes between and makes contact with the embossing roller and the backing roll, the embossing roller imparting a predefined pattern into the material; and,
as a temperature of the embossing roller increases due to contact with the material, reducing the temperature of the embossing roller such that the temperature of the embossing roller remains below the temperature of the material but above the reference temperature.

2. The method of claim 1, further comprising, prior to feeding the material between the embossing roller and the backing roll, maintaining the embossing roller at least substantially at an ambient temperature.

3. The method of claim 1, further comprising, prior to feeding the material between the embossing roller and the backing roll, heating the material to the temperature greater than the reference temperature.

4. The method of claim 1, further comprising, as the material begins to pass between the embossing roller and the backing roll, positionally adjusting one or more of the embossing roller and the backing roller to close the gap therebetween.

5. The method of claim 1, wherein the reference temperature is an ambient temperature of a room in which the embossing roll, the backing roll, and the material are located.

6. The method of claim 1, wherein positionally maintaining the embossing roller and the backing roller so that the embossing roller and the backing roller define the gap therebetween prevents any liquid condensing on the backing roller from being transferred to the embossing roller prior to the material passing between the embossing roller and the backing roll.

7. The method of claim 1, wherein maintaining the temperature of the backing roller below the reference temperature comprises passing coolant through the backing roller.

8. The method of claim 1, wherein maintaining the temperature of the backing roller below the reference temperature improves imparting of the predefined pattern from the embossing roller into the material.

9. The method of claim 1, wherein reducing the temperature of the embossing roller such that the temperature of the embossing roller remains below the temperature of the material but above the reference temperature comprises passing coolant through the embossing roller.

10. The method of claim 1, wherein reducing the temperature of the embossing roller such that the temperature of the embossing roller remains below the temperature of the material but above the reference temperature prevents any liquid from condensing on the embossing roller while still permitting the predefined pattern to be properly imparted from the embossing roller into the material.

11. The method of claim 1, wherein positionally maintaining the embossing roller and the backing roller so that the embossing roller and the backing roller define the gap therebetween, and reducing the temperature of the embossing roller such that the temperature of the embossing roller remains below the temperature of the material but above the reference temperature, prevents liquid from condensing or being transferred onto the embossing roller without having to maintain a humidity of a room in which the embossing roll, the backing roll, and the material are located.

12. An embossing system comprising:
a backing roller;
an embossing roller having a surface with a predefined pattern to be imparted into a material passing between the embossing roller and the backing roller;
a positional mechanism to control a position of the embossing roller and a position of the backing roller in relation to one other such that prior to the material passing between the embossing roller and the backing roller a gap is maintained between the embossing roller and the backing roller;
a heating mechanism to heat the material prior to the material passing between the embossing roller and the backing roller;
a first cooling mechanism to cool the backing roller below a reference temperature; and,
a second cooling mechanism to cool the embossing roller to below a temperature of the material but above the reference temperature.

13. The embossing system of claim 12, wherein the embossing roller is permitted to remain at least substantially at an ambient temperature prior to the material passing between the embossing roller and the backing roller, such that the second cooling mechanism is to cool the embossing roller as heat from the material is transferred to the embossing roller while the material passes between the embossing roller and the backing roller.

14. The embossing system of claim 12, wherein the positional mechanism is to close the gap between the embossing roller and the backing roller as the material begins to pass between the embossing roller and the backing roller.

15. The embossing system of claim 12, wherein the reference temperature is an ambient temperature of a room in which the embossing roll, the backing roll, and the material are located.

16. The embossing system of claim 12, wherein maintaining the gap between the embossing roller and the backing roller, and cooling the embossing roller to below the temperature of the material but above the reference temperature, prevents liquid from condensing or being transferred onto the embossing roller without having to maintain a humidity of a room in which the embossing roll, the backing roll, and the material are located.

17. A computer-readable medium having one or more computer programs stored thereon to perform a method comprising:
maintaining a temperature of a backing roller below a reference temperature; prior to feeding material between the embossing roller and the backing roller to cause the embossing roller to impart a predefined pattern into the material;
heating the material to a temperature greater than a reference temperature;
permitting a temperature of the embossing roller to at least substantially reached an ambient temperature;
positionally maintaining the embossing roller and a backing roller so that the embossing roller and the backing roller define a gap therebetween;
feeding material between the embossing roller and the backing roller to cause the embossing roller to impart the predefined pattern into the material;
as the material passes between the embossing roller and the backing roller,
positionally adjusting one or more of the embossing roller and the backing roller to close the gap therebetween; and,
reducing the temperature of the embossing roller as the temperature of the embossing roller increases due to contact with the material, so that the temperature of the embossing roller remains below the temperature of the material but above the reference temperature.

18. The computer-readable medium of claim 17, wherein the reference temperature is the ambient temperature of a room in which the embossing roll, the backing roll, and the material are located.

19. The computer-readable medium of claim 17, wherein positionally maintaining the embossing roller and the backing roller so that the embossing roller and the backing roller define the gap therebetween prevents any liquid condensing on the backing roller from being transferred to the embossing roller prior to the material passing between the embossing roller and the backing roll.

20. The computer-readable medium of claim 17, wherein reducing the temperature of the embossing roller such that the temperature of the embossing roller remains below the temperature of the material but above the reference temperature prevents any liquid from condensing on the embossing roller while still permitting the predefined pattern to be properly imparted from the embossing roller into the material.
